(19) United States
(12) Patent Application Publication
(10) Pub. No.: US 2005/0234814 A1
(43) Pub. Date: Oct. 20, 2005

(54) System and method for allocating loans

(76) Inventors: Cuyler D. Jones, Littleton, CO (US); Gregory M. Savoy JR., Parker, CO (US); Richard L. Coleman, Firestone, CO (US); Edward A. Mathias, Highlands Ranch, CO (US)

Correspondence Address: SHERIDAN ROSS PC, 1560 BROADWAY, SUITE 1200, DENVER, CO, 80202, US

(21) Appl. No.: 10/826,443

(22) Filed: Apr. 16, 2004

(51) Int. Cl. G06F 17/60

(52) U.S. Cl. 705/38

(57) ABSTRACT

A system and method for allocating loans among a plurality of financial or lending entities is disclosed. The system and method match loan applications with lending entities having funds available for lending to that applicant according to one or more rules. In one embodiment, for example, a method comprises receiving information associated with a loan application, determining whether each of a plurality of lending entities is eligible to fund the loan application, prioritizing at least a portion of the eligible lending entities according to at least one predetermined rule, and selecting an eligible lending entity from the prioritized eligible lending entities. In another embodiment, a system comprises at least one data storage device comprising information associated with a plurality of lending entities available for lending and information associated with a loan application. The system further comprises an allocation engine comprising a processor. The processor is adapted to determine whether each of the plurality of lending entities is eligible to fund the loan application, prioritize at least a portion of the eligible lending entities according to at least one predetermined rule and select an eligible lending entity from the prioritized eligible lending entities.

### FIELD OF THE INVENTION

The present invention relates to a system and method for allocating loans and, more particularly, to a system and method for allocating loans among a plurality of lending entities according to one or more rules.

### BACKGROUND OF THE INVENTION

Lending entities lend money to loan applicants for a variety of purposes. The applicants may use the funds to make a purchase such as for real estate or an automobile, start a business, fund an education or the like. The lending entities may comprise traditional or non-traditional lending sources. For example, credit unions, banks, savings & loans, trusts, venture capital groups, automobile dealerships, automobile financing companies, loan portfolio funds, individual lenders, groups of lenders or other sources of funds may provide loans to an applicant.

Lending entities typically have criteria that must be met by an applicant in order to qualify to receive the entities' funds. A lending entity may be limited to, for example, providing loan funds for a specific purpose or to applicants located within a particular geographic region. Such geographic regions may be defined according to one or more different methodologies such as zip codes, metropolitan areas, counties, states, regions, countries and the like. A lending entity may also decline to accept loans for a variety of reasons. A lending entity, for example, may decline a loan based upon the loan terms (e.g., the annual percentage rate (APR)). A federal credit union, for example, must decline a loan where the APR is above a government imposed cap (e.g., 18%). A lending entity may also decline a loan based upon the loan type. For example, lending entities may limit the loans they provide to particular types of uses, e.g., automobile loans or real estate mortgages, from certain sources, e.g., mortgage brokers, or having a particular type of risk, e.g., non-standard loans. A lending entity, for example, may also decline loans from applicants that do not meet specific rules for eligibility. A credit union, for example, may decline a loan for an applicant that is not a member of the credit union. Thus, a lending entity may require that a loan application satisfy certain criteria before loaning money to an applicant.

Lending entities also expand their ability to provide loans to applicants by lending through one or more associations. An association typically comprises multiple lending entities who affiliate for a common purpose. An association may be formed, for example, to offer a more comprehensive suite of products and services to its customers (e.g, to better serve an under-served segment of the community by offering all available credit union products and services to those who join the association (e.g., home mortgages, automobile loans, credit cards and banking services). Associations may also be formed to expand the business of member lending entities. An association may be formed, for example, to pool resources of member lending entities, to provide member lending entities access to markets outside their own (e.g., metropolitan, county, state, regional, national and the like) or to form reciprocity or alliances between member lending entities. Each of these associations, in turn, may have their own criteria for providing loans to applicants. Examples of associations include the National Hospice Support Foundation, Consumers United Association and St. John's Hospice.

In addition to the limitations on the types of loans a lending entity will accept, the lending entities typically also have an allocation of funds that are available for lending. Thus, if a particular loan would exceed a lending entity's allocated funds to be lent during a particular time period, the lending entity refuses to fund that loan.

In the automobile industry, for example, customers of automobile dealers often finance the purchase of an automobile. An automobile dealer regularly works with their customers to seek financing for the purchase of an automobile. Often, a customer is rejected by one or more financing entities before the customer is finally approved for a loan to finance the purchase of the automobile. Thus, to obtain a loan to finance the purchase of the automobile, the purchaser or the dealer must file loan applications with multiple lending entities. Further, due to convenience, dealers often steer their customers towards lending entities familiar to the dealers. Thus, lending entities that are unfamiliar to the dealers or their customers are often excluded from lending opportunities.

### SUMMARY OF THE INVENTION

The present invention is directed to a system and method for allocating loans among a plurality of lending entities. The system and method match loan applications with lending entities having finds available for lending to that applicant according to one or more rules.

In one embodiment of the present invention, for example, a method of allocating loans comprises receiving information associated with a loan application. The method further determines whether each of a plurality of lending entities is eligible to fund the loan application. The method prioritizes at least a portion of the eligible lending entities according to at least one predetermined rule and selects an eligible lending entity from the prioritized eligible lending entities.

The information associated with the loan application may comprise any information that may be used to determine if a lending entity is eligible to fund the application. In one embodiment, for example, the information associated with the loan application may include geographical or regional information (e.g., a zip code, metropolitan area, county, state, region or nation) identifying a location of an applicant, personal information identifying a particular applicant (e.g., social security number), collateral information (e.g., location of property for a home loan), purpose of the loan (e.g., automobile, mortgage, refinance, home equity, education) or the like. The information associated with the loan application may also comprise an amount of the loan requested.

Eligibility criteria may be compared to the information associated with the loan application to determine if a lending entity is eligible to fund the loan application. A lending entity, for example, may only lend in a particular region, may only lend up to a maximum amount or may have other criteria that must be met before the lending entity will fund a loan application.

In another embodiment, a system of allocating loans is disclosed in which a data storage device stores information associated with a plurality of lending entities available for lending and information associated with a loan application. The system further comprises an allocation engine comprising a processor for assigning the loan application to a lending entity according to one or more rules. The processor of the allocation engine is adapted to determine whether each of the plurality of lending entities is eligible to fund the loan application, prioritize at least a portion of the eligible lending entities according to at least one predetermined rule and select an eligible lending entity from the prioritized eligible lending entities. The data may be regularly updated, by the lending entities themselves or by third party data processors, and the rules may be revised as necessary.

### BRIEF DESCRIPTION OF THE DRAWINGS

FIG. 1 illustrates a block diagram of a system of the present invention for allocating loans among a plurality of lending entities;

FIG. 2 illustrates a flow diagram of an embodiment of a method for allocating loans among a plurality of lending entities;

FIG. 3 illustrates a flow diagram of an another embodiment of a method for allocating loans among a plurality of lending entities;

FIG. 4 illustrates a data structure showing exemplary information associated with a loan application; and

FIG. 5 illustrates a data structure showing exemplary information associated with a plurality of lending entities.

### DETAILED DESCRIPTION

The present invention is directed to a system and method for allocating loans among a plurality of lending entities. The system and method match loan applications with lending entities having funds available for lending to that applicant according to one or more rules.

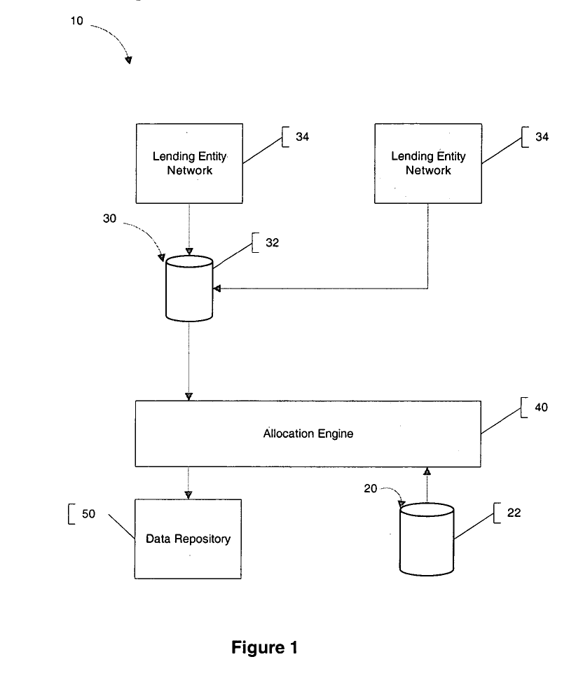

FIG. 1 shows a system diagram of one embodiment of a loan allocation system 10 of the present invention. In this embodiment, the system 10 comprises a loan application information source 20, a lending entity information source 30, an allocation engine 40 and a data repository 50. The loan application information source 20 may comprise any source for receiving loan applications or information associated with loan applications. Preferably, information associated with the loan applications is stored in a database 22 or other data storage device (e.g., memory, memory stick, disk, disk drive, tape, tape drive or the like) in which the information is retrievable by the allocation engine 40. The applications received by the system 10 may be pre-approved or may be approved or rejected after being received by the system 10. The loan applications may be received directly from an applicant, from a lending entity or from a third party (e.g., automobile dealer) in either a hard-copy format (e.g., typed, printed or handwritten) or an electronic format. Where a loan application is received in a hard-copy format, information from the application may entered into the database 22 for use by the system 10, such as by data entry, optical character recognition or barcode reading. An application may also be received electronically, such as via a network connection (e.g., an Internet web site), e-mail messaging, instant messaging, wireless transmission or wired transmission.

The lending entity information source 30 may comprise any source for receiving information related to a plurality of lending entities that have funds to lend to loan applicants. The information, for example, may comprise the funds allocated by a lending entity for lending and/or any rules for determining the eligibility of a loan applicant to receive a loan from the lending entity. The lending entity information source 30 may comprise, for example, a database 32 including the information related to the plurality of lending entities. The database 32 is accessible by the allocation engine 40 for retrieving the information. The database 32 may be maintained on the system 10 (e.g., on a centralized network or system with the allocation engine 40) by a clearing house that allocates loans among the plurality of lending entities, or the database 32 may be maintained remotely (e.g., via one or more lending entities on one or more networks associated with the lending entities) and accessed remotely by the allocation engine 40. One or more of the lending entities may have access to the database 32 (or at least their own information stored in the database 32) so that the individual lending entities may add, edit or delete their own information in the database 32. The lending entities, for example, may access the database 32 via one or more lending entity networks 34 connected to the system 10, a network connection to the system 10 or the like.

The database 32 may also be populated within the system 10 with information relating to a plurality of lending entities. For example, the system 10 may comprise a utility for auto-populating the database 32 by setting up lending zones (e.g., fields of membership, geographic areas, metropolitan zones) and fiduciary information (e.g., total allocated funds and periodic lending limits) for the lending entities. Once the lending entity is added to the database 32, the information is available to the allocation engine 40 for assigning loans to the lending entity.

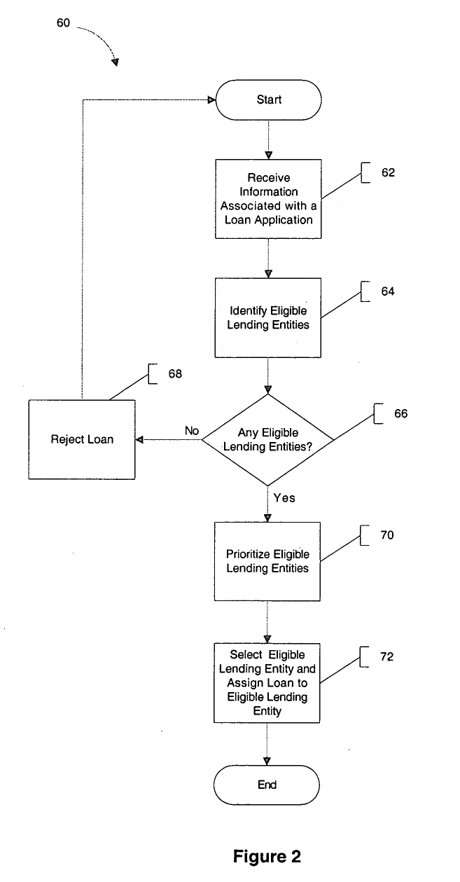

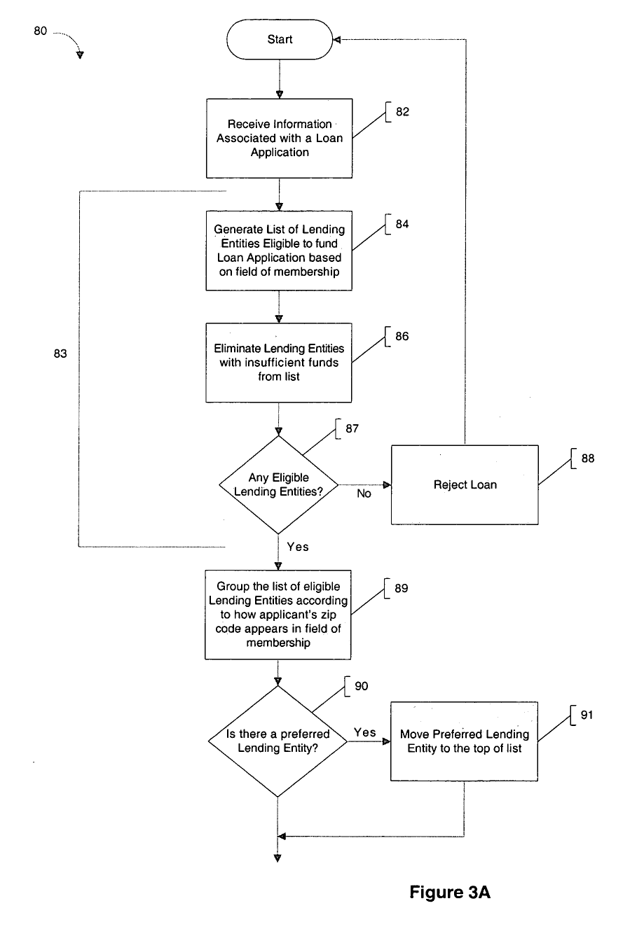

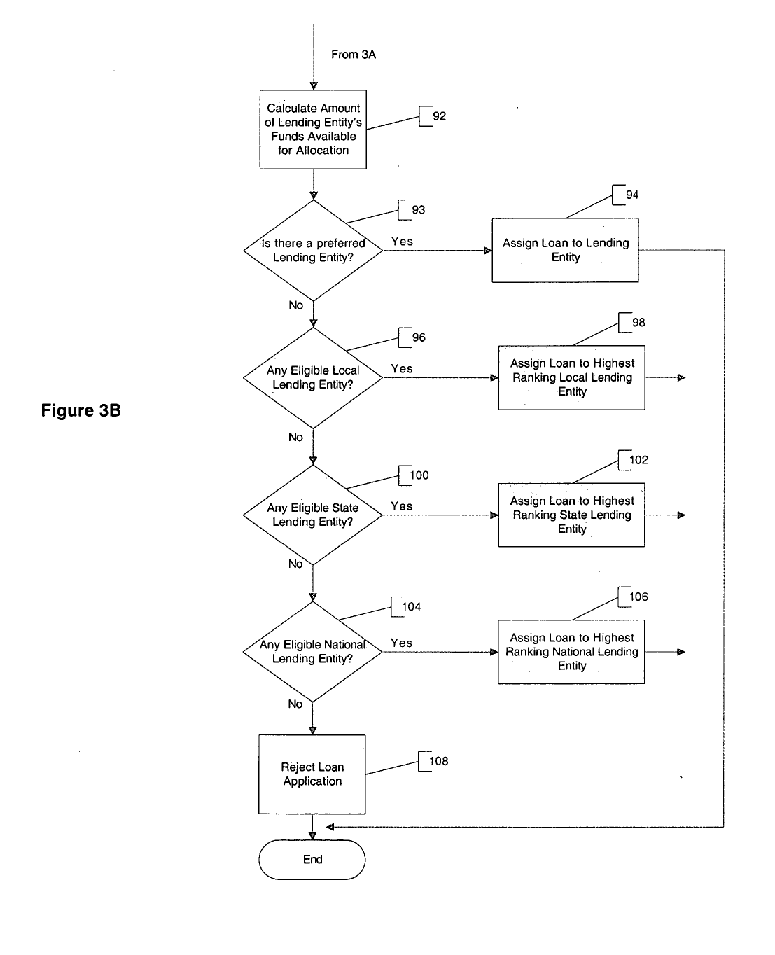

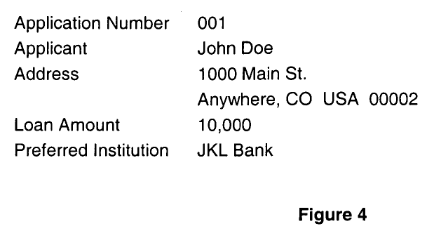

In one embodiment, a clearing house receives information associated with a loan application and matches that loan application with a lending entity. The clearing house may comprise a centralized network or system comprising one or more of the elements of the system 10. The clearing house, for example, may receive information associated with one or more loan applications, access information associated with a plurality of lending entities and allocate the application(s) among the plurality of lending entities. A clearing house may further enlist a plurality of lending entities for providing loans to loan applicants. The clearing house, may also offer a loan allocation service to individual loan applicants or to third parties (e.g., automobile dealerships) for obtaining loans for their clients or customers. Thus, when a customer desires a loan to purchase an item (e.g, an automobile) from a seller, the seller or the applicant may provide a loan application to the clearing house to be matched with one or more of the lending entities associated with the clearing house. In this manner, the applicant can obtain a loan from one of a plurality of lending entities while only filing a single loan application with the clearing house instead of filing an application with each individual lending entity. The clearing house compares the information associated with the loan applications received with the information associated with one or more lending entities in order to assign the loan application to a lending entity such as described below with reference to FIGS. 2 and 3. After the loan is assigned to a lending entity, the lending entity and the loan applicant are informed of the allocation.

After a loan application is assigned to a lending entity, allocation engine 40 may notify the selected lending entity and/or the applicant. The allocation engine 40, for example, may notify the lending entity and/or the applicant electronically, such as via electronic mail, instant messaging, facsimile or the like. The allocation engine 40 may also notify the lending and/or the applicant by other means such as by mail, courier, telephone or the like. The selected lending entity may be contractually bound to find the loan application or may be free to reject the loan application. If the lending entity rejects the loan application, the application may be placed back into a queue of loan applications to be re-allocated or may be rejected.

FIG. 2 shows a flow diagram of one embodiment of a method 60 of operation of the allocation engine 40 of the present invention. As shown in FIG. 2, the allocation engine 40 receives information associated with a loan application in operation 62. The information associated with the loan application preferably comprises identifying information and a loan amount. The identifying information may comprise, for example, geographical information (e.g., a zip code) identifying a location of an applicant, personal information identifying a particular applicant (e.g., social security number), collateral information (e.g., location of property for a home loan), information relating to the purpose of the loan (e.g., automobile, mortgage, refinance, home equity, education) or the like. The information associated with the loan application may be received from an applicant, a lending entity, a third party (e.g., an automobile dealer) or may be stored on the system 10. If the information associated with the loan application is incomplete, the method 60 may reject the application or inform the applicant that additional information is required before the application will be assigned to a lending entity.

The allocation engine 40 then identifies eligible lending entities for lending money to the loan applicant in operation 64. The lending entities available to the system 10 may comprise traditional or non-traditional lending sources. The system may include, for example, credit unions, banks, savings & loans, trusts, venture capital groups, automobile dealerships, automobile financing companies, loan portfolio funds, individual lenders, groups of lenders and/or other sources of loan funds. In one embodiment, for example, the allocation engine 40 sequentially checks each lending entity available to the system 10 to determine whether that lending entity is eligible to fund a particular loan application.

A lending entity is eligible to loan money to an applicant if the loan application meets criteria required by the lending entity and the lending entity has sufficient funds to lend the loan amount requested in the loan application. The criteria required may be general criteria that apply to each of the lending entities available for lending or unique criteria that apply to one or more specific lending entities available for lending.

Eligibility criteria may be imposed, for example, by the lending entities themselves, government regulations or the allocation engine 40. A lending entity may only be eligible to lend money within a particular geographic region. A federal credit union having an annual percentage rate (APR) cap of 18% imposed by government regulations, for example, must decline a loan having an APR greater than the cap. Other lending entities limit the loans they provide to particular types of uses (e.g., automobile loans or real estate mortgages), from certain sources (e.g., mortgage brokers), exceeding a lending cap (e.g., the loan amount exceeds a cap on a per loan basis or the applicant would exceed an aggregate cap for total loans made to an applicant) or having a particular type of risk (e.g., non-standard loans). A lending entity, such as a credit union, for example, may also limit their lending to members or other applicants meeting specific rules for eligibility. If a loan application meets the criteria of a lending entity and the lending entity has sufficient funds to make the loan, the lending entity is identified as an eligible lending entity for providing the loan, and the allocation engine 40 adds the lending entity to a list of eligible lending entities for the particular loan application in process.

The allocation engine 40 then determines whether any lending entities were identified as eligible in operation 66 for a particular loan. If no lending entities are eligible to fund the loan, the loan application is rejected in operation 68 and the allocation engine 40 returns to operation 62 to start over with a new loan application. The method 60 may process one loan application at a time (e.g., as the applications are received) or may process multiple loan applications (e.g., batch processing). A batch process, for example, may process applications serially or in parallel (e.g., using multi-tasking or multi-threading processing).

If one or more lending entities were identified as eligible to fund the loan, however, the allocation engine prioritizes at least a portion of the list of eligible lending entities according to one or, more predetermined rules in operation 70. The rules may be altered over time depending upon changes to the lending practices of one or more lending entities. As described above, for example, information associated with the lending entities (e.g., eligibility criteria or other rules) may be maintained by the lending entities themselves, by a clearing house or in some other manner. Thus, a lending entity may access the information associated with itself and add, edit or delete the rules that are applicable to its lending practices. The rules may also be added, edited or deleted by a clearing house or other third party managing the system to adjust for lending practices of one or more lending entities.

In addition to lending entity-specific rules, other rules relating to the allocation of loan applications to financial entities may also be altered. For example, as the system 10 is implemented, the rules may be adjusted to increase the efficiency or efficacy of the system 10. These adjustments may be altered, for example, by a system manager or clearing house where desired. The rules may also be adjusted automatically in the system, such as through Bayesian and/or genetic programming techniques. Such programming techniques, for example, may employ statistical selection processes that can essentially make the system self-learning. By defining a set of marker attributes for a loan, the system may examine the attributes and put them into categories for selection. The system will generate exceptions that a user or system manager can use to improve the efficiency and/or efficacy of the allocation process. In addition, the system may utilize genetic programming techniques to improve the allocation process by testing and/or timing itself to explore more efficient allocation techniques.

Further, where the system fails to allocate a loan under the implemented method, the system 10 may further incorporate Bayesian selection and marker techniques such as described above to group the loan allocations into categories, such as “Approved,” “Declined” and “Unknown.” A user or system manager can then analyze the categories (e.g., Unknown) to adjust the rules for allocation to increase the efficiency and/or efficacy of the allocation process.

A particular lending entity may be preferred for the loan application and, thus, the highest ranking lending entity for the loan application if it is eligible to fund the application. For example, if the loan applicant identified the lending entity or has a pre-existing business arrangement with the lending entity, the lending entity may be preferred for the loan application. A seller (e.g., an automobile dealer) may also have a business relationship with one or more lending entities that provides for preferred lending entities in particular circumstances. The allocation engine 40 may further prioritize by ranking local lending entities higher than other lending entities, may prioritize by the amount of funds the allocation engine 40 has previously assigned to loan applicants for the lending entities or may prioritize based upon other criteria, such as weighting factors (e.g., a lending entity or association may be weighted due to factors such as past performance (e.g, rapid funding of loans, loan acceptance rates or minimal customer complaints), favorable or preferred contracts with a clearing house or the like).

The allocation engine 40 may select an eligible lending entity from the list of eligible lending entities based upon the priority determination of operation 70 and assign the loan application to that lending entity in operation 72. The selection process, for example, may determine the highest priority lending entity and assign the loan application to that lending entity. The allocation engine, may also rank all or a portion of the eligible lending entities before selecting an eligible lending entity to fund a loan.

The application may be pre-approved prior to the execution of the method 60 of allocating loans is executed or may be approved or rejected during the execution of the method 60 (e.g, during operation 68). If the application is rejected during the execution of the method 60, the allocation engine 40 returns to operation 62 to start over with another application. If the application has been approved, either prior to the execution of the method 60 or during the execution of the method 60, the method proceeds to select a lending entity to assign the loan application.

FIG. 3 shows a flow diagram of an alternative embodiment of a method 80 of operation of the allocation engine 40 of the present invention. In this embodiment, for example, a clearing house may process the loan allocation method 80 for allocating loans for automobile purchases at automobile dealerships. As shown in FIG. 3A, the allocation engine 40 receives information associated with a loan application in operation 82. In this embodiment, the information associated with the loan application may originate from an automobile dealership from the dealer or from a purchaser of an automobile. The information associated with the loan application preferably comprises at least a zip code (e.g., of the applicant) and a loan amount.

The information associated with the loan application is then used to determine whether one or more lending entities are eligible to fund the loan in operation 83. A clearing house, for example, may contract with traditional or non-traditional lending entities. The lending entities may comprise, for example, credit unions, banks, savings & loans, trusts, venture capital groups, automobile dealerships, automobile financing companies, loan portfolio funds, individual lenders, groups of lenders or other sources of loan funds. Where certain lending entities require additional conditions to be met before the lending entity will fund a particular loan, the clearing house further analyzes the applications to determine whether the additional criteria have been met.

In this embodiment, the clearing house generates a list of lending entities eligible to fund a particular loan by comparing the information associated with the loan application (e.g., the applicant's zip code) to a Field of Membership of each available lending entity in operation 84. The Field of Membership may comprise a local Field of Membership for which the lending entity may directly provide loans. The lending entities may also expand their Fields of Membership by lending through one or more associations. Each of these associations has its own Field of Membership, which may be much larger than a particular lending entity's local Field of Membership. Examples of associations comprise metropolitan, county, state, regional, national or other associations. In addition to these types of geographic associations, the associations may be formed using any other set of rules, such as reciprocity, alliances and the like.

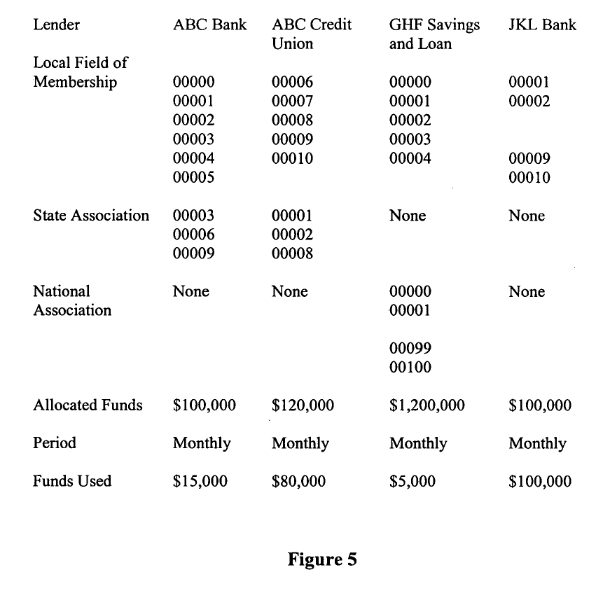

FIG. 5, for example, shows an exemplary data structure associated with the lending entities maintained in the database 32 including local and association Fields of Membership. In this embodiment, the data structure includes entries for ABC Bank, DEF Credit Union, GHI Savings & Loan and JKL Bank lending entities. Each of the lending entities include local and/or association Fields of Membership comprising lists of zip codes for which the lending entities are eligible to fund loans. Eligibility for particular regions may be determined, for example, by the lending entity itself, by government regulations, by a clearing house allocating loans or any other suitable method.

The allocation engine 40 also eliminates lending entities from the list of eligible lending entities if the current loan application would exceed the lending entity's allocated funds for lending in operation 86. The allocated funds for a particular lending entity may comprise an absolute amount (e.g., $1,000,000) or an amount that may be lent within a repeating period of time (e.g., $100,000 per month). The allocation engine 40 determines how much of the lending entity's allocated funds available for lending has already been used. In one embodiment, for example, this includes money that has already been loaned out plus a projection of how much of the money has been assigned to loans that are in the lending entity's funding “pipeline” (i.e., funds that have been approved and assigned but not yet closed). If this amount plus the amount of the loan applied for is greater than the lending entity's allocated funds to be lent, or more than a threshold (e.g., 90%) of the allocated funds, the lending entity is eliminated from the list of lending entities eligible to fund the loan application.

The allocation engine 40 determines if there are any lending entities eligible to fund the loan application in operation 87. If there are no eligible lending entities, the allocation engine 40 rejects the application in operation 88 and returns to operation 82. If at least one lending entity is eligible to fund the loan application, however, the allocation engine proceeds to operation 89.

In this embodiment, the allocation engine 40 groups the list of eligible lending entities according to how the applicant's zip code appears in the lending entities° Fields of Membership (i.e., local or association) in operation 89. In the embodiment shown in FIG. 5, for example, the allocation engine groups the lending entities by whether the applicant's zip code appears in the lending entities' local Field of Membership, state association Field of Membership and/or national association Field of Membership. A lending entity may appear in more than one group.

In operation 90, the allocation engine 40 also determines whether there is a preferred lending entity for the loan application and, if so, ranks the lending entity at the top of the list for that loan application in operation 91. A preferred lending entity may be designated by the applicant or a third party (e.g., an automobile dealership). An applicant, for example, may prefer to deal with a particular lending entity, assuming that the criteria of the lending entity are met. A retailer, such as an automobile dealership, may also have business relationships with a lending entity that requires the allocation engine to assign the loan to that lending entity if the lending entity's criteria are met for that loan application. Thus, in the present embodiment, if a loan applicant meets the Field of Membership requirements and a preferred lending entity has sufficient funds remaining in its allocation, the allocation engine 40 ranks the preferred lending entity at the top of the list of lending entities for the loan application. The allocation engine 40 may assign the loan application to the preferred lending entity and return to operation 82 or may proceed to operation 92. If there is no preferred lending entity, however, the allocation engine 40 proceeds to operation 92.

Thus, in an embodiment in which the system 10 includes lending entities that can have a zip code appear in a local Field of Membership, a state association and a national association, the allocation engine 40 would group the eligible lending entities in the following order:
1. The preferred lending entity, if any (see operation 90).
2. Lending entities with the applicant's zip code listed in their local Field of Membership.
3. Lending entities with the applicant's zip code listed in their Field of Membership through a state association.
4. Lending entities with the applicant's zip code listed in their Field of Membership through a national association.

The allocation engine 40 also calculates how much of each lending entity's allocated funds have already been used in operation 92. This calculation may comprise an absolute amount (e.g., $40,000) or a percentage of the allocated funds of the lending entity (e.g., 40%).

After calculating the how much of each lending entity's allocated funds have already been used, the allocation engine 40 prioritizes the list of eligible lending entities by sorting them according to the amount of their allocated funds that have already been used, whether by absolute amounts or by percentages. After sorting the list of eligible lending entities by the amount of their allocated funds that have been used, the list appears as follows:
1. The preferred lending entity, if any (see operation 90).
2. Lending entities with the applicant's zip code listed in their local Field of Membership sorted in order of their allocated funds used.
3. Lending entities with the applicant's zip code listed in their Field of Membership through a state association sorted in order of their allocated funds used.
4. Lending entities with the applicant's zip code listed in their Field of Membership through a national association sorted in order of their allocated funds used. By ranking a lending entity that has used a smaller amount of its allocated funds than other lending entities, the allocation engine 40 distributes the loans in an equitable manner among the lending entities.

The allocation engine 40 then selects an eligible lending entity based upon the priority of the eligible lending entities and assigns the loan application to the selected eligible lending entity. In this embodiment, for example, the allocation engine first determines if there is a preferred lending entity for the loan in operation 93. If there is a preferred lending entity, the allocation engine 40 selects that lending entity for the loan application in operation 94. If there is not a preferred lending entity for the loan application, however, the allocation engine 40 determines whether there are any lending entities available that have the applicant's zip code in their local Fields of Membership in operation 96. If so, the allocation engine 40 selects the highest ranking lending entity having the applicant's zip code in its local Field of Membership for the loan application in operation 98. In this embodiment, for example, the highest ranking lending entity in this group is determined as a result of the sorting operation by which the lending entities having the applicant's zip code in their local Field of Membership (e.g., the lending entity of the group having used the least amount or the least percentage of its allocated funds).

If there are no eligible lending entities having the applicant's zip code in their local Field of Membership, the allocation engine 40 determines whether there are any available lending entities that loan through state associations that have the applicant's zip code in the association's Field of Membership in operation 100. If one or more lending entities are available that lend through a state association having the applicant's zip code in its Field of Membership, the allocation engine 40 selects the highest ranking lending entity in that group for the loan application in operation 102. Again, in this embodiment, the highest ranking lending entity in this group is determined as a result of the sorting operation by which the lending entities that lend through a state association having the applicant's zip code in its Field of Membership (e.g., the lending entity of the group having used the least amount of its allocated funds).

If there are no lending entities available that lend through a state association having the applicant's zip code in the association's Field of Membership, however, the allocation engine 40 determines whether there are any available lending entities that loan through national associations having the applicant's zip code in the association's Field of Membership in operation 104. If one or more lending entities are available that lend through national associations having the applicant's zip code in their Fields of Membership, the allocation engine 40 selects the highest ranking lending entity in that group for the loan application in operation 106. Again, in this embodiment, the highest ranking lending entity in this group is determined as a result of the sorting operation by which the lending entities that lend through a national association having the applicant's zip code in its Field of Membership (e.g., the lending entity of the group having used the least amount of its allocated funds).

After an eligible lending entity is selected, the allocation engine 40 preferably increments the amount of allocated funds for that lending entity by the amount of the loan assigned to the lending entity.

If no lending entities are available to loan funds to the applicant, however, the loan application is rejected in operation 108 and the allocation engine 40 returns to operation 82 and the allocation engine 40 starts over with another loan application.

Although the present invention has been described in conjunction with its preferred embodiments, it is to be understood that modifications and variations may be resorted to without departing from the spirit and scope of the invention as those skilled in the art readily understand. Such modifications and variations are considered to be within the purview and scope of the invention and the appended claims.

1. A method for allocating loans among a plurality of lending entities comprising:
receiving information associated with a loan application;
determining whether each of a plurality of lending entities is eligible to fund the loan application;
prioritizing at least a portion of eligible lending entities according to at least one predetermined rule; and
selecting an eligible lending entity from the prioritized eligible lending entities.

2. The method of claim 1, wherein the information associated with the loan application comprises a zip code.

3. The method of claim 2, wherein the operation of determining whether a lending entity is eligible to fund the loan application comprises determining whether the lending entity is eligible to fund a loan application associated with the zip code.

4. The method of claim 1, wherein the information associated with the loan application comprises a loan amount.

5. The method of claim 4, wherein the operation of determining whether a lending entity is eligible to fund the loan application comprises determining whether the lending entity has funds sufficient to lend the loan amount.

6. The method of claim 1, wherein the information associated with the loan comprises at least one of a regional descriptor, a national descriptor, a metropolitan descriptor, a county descriptor and a geographic descriptor.

7. The method of claim 1, wherein the operation of determining whether a lending entity is eligible to fund the loan application comprises determining whether the lending entity is eligible to lend in the at least one of a regional descriptor, a national descriptor, a metropolitan descriptor, a county descriptor and a geographic descriptor.

8. The method of claim 1, wherein the operation of determining whether a lending entity is eligible to fund the loan application comprises determining whether the loan application meets at least one predetermined criteria of the lending entity.

9. The method of claim 1, wherein the operation of prioritizing at least a portion of the eligible lending entities comprises determining whether a preferred lending entity exists for funding the loan application.

10. The method of claim 1, wherein the operation of prioritizing at least a portion of the eligible lending entities comprises sorting the eligible lending entities according to an amount of allocated funds that are available for lending.

11. The method of claim 1, wherein the operation of prioritizing at least a portion of the eligible lending entities comprises determining whether a local lending entity exists for funding the loan application.

12. The method of claim 1, wherein the operation of prioritizing at least a portion of the eligible lending entities comprises determining whether a lending entity is eligible to fund the loan application through an association of lending entities.

13. The method of claim 1, wherein the operation of prioritizing at least a portion of the eligible lending entities comprises grouping the eligible lending entities.

14. The method of claim 13, wherein the operation of grouping the eligible lending entities comprises grouping the eligible lending entities according to whether the lending entities are eligible to fund the loan application on their own or through an association of lending entities.

15. The method of claim 1, further comprising generating a list of at least one lending entity eligible to fund the loan application.

16. The method of claim 1, further comprising assigning the loan application to the selected eligible lending entity.

17. A system for allocating loans comprising:
at least one data storage device comprising:
information associated with a plurality of lending entities available for lending, and
information associated with a loan application; and
an allocation engine comprising a processor, the processor adapted to:
determine whether each of the plurality of lending entities is eligible to fund the loan application,
prioritize at least a portion of the eligible lending entities according to at least one predetermined rule, and
select an eligible lending entity from the prioritized eligible lending entities.

18. The system of claim 17, wherein the information associated with the loan application comprises a zip code.

19. The system of claim 18, wherein the processor is adapted to determine whether each of a plurality of lending entities is eligible to fund the loan application by determining whether the lending entity is eligible to fund a loan application associated with the zip code.

20. The system of claim 17, wherein the information associated with the loan application comprises a loan amount.

21. The system of claim 20, wherein the processor is adapted to determine whether each of a plurality of lending entities is eligible to fund the loan application by determining whether the lending entity has funds sufficient to lend the loan amount.

22. The system of claim 17, wherein the information associated with the loan comprises a location descriptor from at least one of: a zip code descriptor, a metropolitan region descriptor, a county descriptor, a state descriptor, a regional descriptor, a national descriptor and a geographic descriptor.

23. The system of claim 22, wherein the processor is adapted to determine whether each of a plurality of lending entities is eligible to fund the loan application by determining whether the lending entity is eligible to lend in a location corresponding to the location descriptor of the information associated with the loan application.

24. The system of claim 17, wherein:
the information associated with the plurality of lending entities comprises at least one predetermined criteria of a lending entity, and
the processor is adapted to determine whether each of a plurality of lending entities is eligible to fund the loan application by determining whether the loan application satisfies the at least one predetermined criteria of the lending entity.

25. The system of claim 17, wherein the processor is adapted to prioritize at least a portion of the eligible lending entities by determining whether one of the eligible lending entities comprises a preferred lending entity for the loan application.

26. The system of claim 17, wherein:
the information associated with the plurality of lending entities comprises an amount of funds allocated for lending that are available, and
the processor is adapted to prioritize at least a portion of the eligible lending entities by sorting the eligible lending entities according to the amount of allocated funds that are available for lending.

27. The system of claim 17, wherein the processor is adapted to prioritize at least a portion of the eligible lending entities by determining whether at least one of the eligible lending entities comprises a local lending entity for the loan application.

28. The system of claim 17, wherein the processor is adapted to prioritize at least a portion of the eligible lending entities by determining whether a lending entity is eligible to fund the loan application through an association of lending entities.

29. The system of claim 17, wherein the processor is adapted to prioritize at least a portion of the eligible lending entities by grouping the eligible lending entities.

30. The system of claim 29, wherein the processor is adapted to group the eligible of lending entities by grouping the eligible lending entities according to whether the lending entities are eligible to fund the loan application on their own or through an association of lending entities.

31. The system of claim 17, wherein the data storage device comprises a database.

32. The system of claim 17, wherein the processor is further adapted to generate a list of at least one lending entity eligible to fund the loan application,

33. The system of claim 17, wherein the processor is further adapted to assign the loan application to the selected eligible lending entity.

34. The system of claim 33, wherein the processor is further adapted to notify the selected eligible lending entity.

35. The system of claim 17, wherein the information associated with a plurality of lending entities comprises eligibility criteria for at least one of the plurality of lending entities.

36. The system of claim 17, wherein the information associated with a plurality of lending entities comprises an amount of allocated funds for at least one of the plurality of lending entities.

37. The system of claim 17, wherein the information associated with a plurality of lending entities comprises a cap for at least one of the plurality of lending entities.

38. The system of claim 37, wherein the cap comprises a cap of funds allocated for an individual loan.

39. The system of claim 37, wherein the cap comprises a cap of funds allocated for a plurality of loans.

40. The system of claim 17, wherein the information associated with a plurality of lending entities comprises an affiliation of at least one of the plurality of lending entities.

41. The system of claim 17, wherein the information associated with a plurality of lending entities comprises information related to an association in which at least one of the plurality of lending entities participates.

42. The system of claim 17, wherein the loan application comprises an application for financing acquisition of an automobile.

43. The system of claim 17, wherein the information associated with the plurality of lending entities is stored on a plurality of networks associated with the plurality of lending entities.

44. The system of claim 17, wherein the information associated with the plurality of lending entities is stored on a network of a clearing house.

45. A method for allocating automobile loans among a plurality of lending entities comprising:
receiving information associated with a automobile financing application;
determining whether each of a plurality of lending entities is eligible to fund the automobile financing application;
prioritizing at least a portion of the eligible lending entities according to at least one predetermined rule; and
selecting an eligible lending entity from the prioritized eligible lending entities.

46. The method of claim 45, wherein the information associated with the automobile financing application is received from an automobile dealership.

47. The method of claim 45, wherein the information associated with the automobile financing application is received by a clearing house.

48. The method of claim 45, further comprising generating a list of at least one lending entity eligible to fund the automobile financing application.

49. The method of claim 45, further comprising assigning the loan application to the selected eligible lending entity.

50. A system for allocating automobile loan applications among a plurality of lending entities comprising:
at least one data storage device comprising:
information associated with a plurality of lending entities available for providing automobile financing, and
information associated with an automobile financing application; and
an allocation engine comprising a processor, the processor adapted to:
determine whether each of the plurality of lending entities is eligible to fund the automobile financing application,
prioritize the list of eligible lending entities according to at least one predetermined rule, and
select an eligible lending entity from the prioritized eligible lending entities.

51. A method for allocating loan applications among a plurality of lending entities comprising:
storing information associated with a plurality of lending entities, wherein the information associated with the plurality of lending entities comprises at least one eligibility criteria;
updating the information associated with the plurality of lending entities;
receiving information associated with a loan application; and
determining a lending entity of the plurality of lending entities to assign the loan application based upon the at least one eligibility criteria; and
assigning the loan application to the lending entity.

52. The method of claim 51, wherein the information associated with the plurality of lending entities is stored on a centralized network.

53. The method of claim 51, wherein the information associated with the plurality of lending entities is stored on a centralized data storage device.

54. The method of claim 51, wherein the information associated with the plurality of lending entities is stored on a plurality of networks associated with the plurality of lending entities.

55. The method of claim 51, wherein the operation of updating the information associated with the plurality of lending entities is performed from a clearing house.

56. The method of claim 51, wherein the operation of updating the information associated with the plurality of lending entities is performed from a network associated with at least one of the plurality of lending entities.

57. The method of claim 51, wherein the operation of updating the information associated with the plurality of lending entities is performed by at least one of the plurality of lending entities.
